(19) United States
(12) Patent Application Publication
(10) Pub. No.: US 2025/0033062 A1
(43) Pub. Date: Jan. 30, 2025

(54) ECCENTRIC ROLLER CRUSHER

(71) Applicant: FLSmidth A/S, Valby (DK)

(72) Inventor: Piotr Szczelina, Beckum (DE)

(21) Appl. No.: 18/711,608

(22) PCT Filed: Nov. 18, 2022
(86) PCT No.: PCT/IB2022/061138

§ 371 Date: May 19, 2024

(30) Foreign Application Priority Data
Nov. 19, 2021 (DE) 10 2021 213 035.6

(51) Int. Cl. B02C 4/12; B02C 4/42

(52) U.S. Cl. CPC B02C 4/12; B02C 4/42

(57) ABSTRACT

The present invention relates to an eccentric roller crusher 10 with a crusher housing 60, a drive shaft 20, a roller 30 supported eccentrically and rotatably on the drive shaft 20, and a rocker 40, characterised in that between the drive shaft 20 and the roller 30 or between the roller 30 and the crusher housing 60, a retardation device is arranged.

The invention relates to an eccentric roller crusher.

Eccentric roller crushers are known from the prior art, for example and particularly from WO 2014/067858 A1 and WO 2014/067882 A2.

An eccentric roller crusher exhibits a crusher housing, through which a drive shaft is directed. A roller is supported eccentrically and rotatably on the drive shaft. The roller is free to rotate about the drive shaft. The eccentric roller crusher also exhibits a rocker. The material introduced is crushed between the roller moved by the eccentric bearing and the rocker. To do this, the drive shaft usually rotates in the direction so that the direction of rotation is directed away from the side of the rocker, thus parallel to the material flow. The coarse material between the roller and the rocker sets the roller in rotation, which is directed upwards on the side of the rocker, therefore, opposite to the usual direction of rotation of the drive shaft. This has the effect that the surface of the roller is loaded as uniformly as possible.

However, comparatively high accelerations may occur on the roller. For example, when starting up the device, due to inertia and friction, without material applied, the roller is set into rotation parallel to the direction of rotation of the drive shaft. If material is now applied, this leads to the first piece, which is greater than the gap between the roller and the rocker, so that the direction of rotation of the roller turns abruptly.

The task of the invention is to reduce the acceleration forces when the speed of the roller changes.

This task is solved by eccentric roller crushers with the characteristics specified in claim 1. Advantageous embodiments ensue from the sub-claims, the following description and the drawings.

The eccentric roller crusher according to the invention exhibits a crusher housing, a drive shaft, a roller eccentrically and rotatably supported on the drive shaft, and a rocker. The drive shaft usually exhibits four bearings, two on the crusher housing and two more on the roller. The eccentric bearing is usually achieved in that the drive shaft exhibits a thickening in the region of the roller, wherein although the thickening exhibits a round cross-section, its axis of symmetry, however, is offset to the side outside the region of the roller, compared with the axis of symmetry.

According to the invention, a retardation device is arranged between the drive shaft and the roller or between the roller and the crusher housing. Whereas usually between the roller and the drive shaft only two round bearings with rollers are arranged, precisely to achieve a free movement of the roller about the drive shaft and therefore as low as possible a resistance is endeavoured, according to the invention, a retardation device is introduced, which brakes rapid movements and preferably particularly rapid movements.

In a further embodiment of the invention, the retardation device is a mechanical brake. For example, the mechanical retardation device or mechanical brake is made of an elastic material, which is in contact with the roller on the side opposite the rocker. Alternatively or additionally, the mechanical retardation device is spring-loaded and/or exerts a force on the roller by means of a shock absorber, preferably on the side opposite the rocker.

In a further embodiment of the invention, the retardation device is a fluid. For example, the fluid is arranged between two round bearings that are arranged between the drive shaft and the roller. According to the prior art, there is only a gas, usually air, here. Shear tension increases with increasing shear velocity, so that as a result high speeds can be avoided. Particularly preferably, the fluid is a non-Newtonian shear-thickening fluid. An example of this is a starch solution. In so doing, the shear tension increases disproportionately with increasing shear velocity, by which small speeds are hardly braked but high speeds are extremely strongly braked.

In a further embodiment of the invention, the retardation device is a fluid coupling, particularly preferably a viscous coupling, also known as a turbo coupling. Particularly preferably, the fluid coupling is arranged between the crusher housing and the roller. A fluid coupling exhibits a pump wheel and a turbine wheel. The braking effect can therefore be adjusted by the viscosity of the fluid, particularly the liquid, used as a fluid.

In a further embodiment of the invention, the retardation device is a magnetic brake. In particular, eddy currents are generated by a magnet, which then generate the braking effect. To do this, the magnets may be arranged for example and preferably on the crusher housing, so that they generate eddy currents in the roller. In this version, the magnetic brake preferably embodies an electromagnet and is therefore switchable. For example, the brake can then be activated if, for example, the eccentric roller crusher is started up, the infeed to material is interrupted and the eccentric roller crusher thus idles or the eccentric roller crusher is shut down.

In a further embodiment of the invention, the retardation device exhibits a counter-rocker, wherein the counter-rocker is arranged on the side of the roller opposite the rocker. To do this, the material infeed is formed as a screen or grating. Preferably, the gap between the counter-rocker and the roller is smaller than the opening size of the grating or screen. As a result, smaller material gets between the roller and the counter-roller compared with the region between the rocker and roller. As a result, no large forces are to be anticipated in the region of the counter-rocker, as the particle size has an upper limit. However, due to the material flow, in the case of suddenly-occurring larger forces, for example, due to a very large particle on the side of the rocker, a counter-force is generated, that prevents too great an acceleration.

In a further embodiment of the invention, the eccentric roller crusher exhibits an inner housing, wherein the roller exhibits an extension region, wherein the extension region is directed coaxially to the drive shaft through the inner housing, wherein the retardation device is arranged outside the inner housing. As a result, the retardation device can be implemented in all the variants described above.

Below, the eccentric roller crusher according to the invention is explained in more detail using one of the illustrative examples in the drawings.

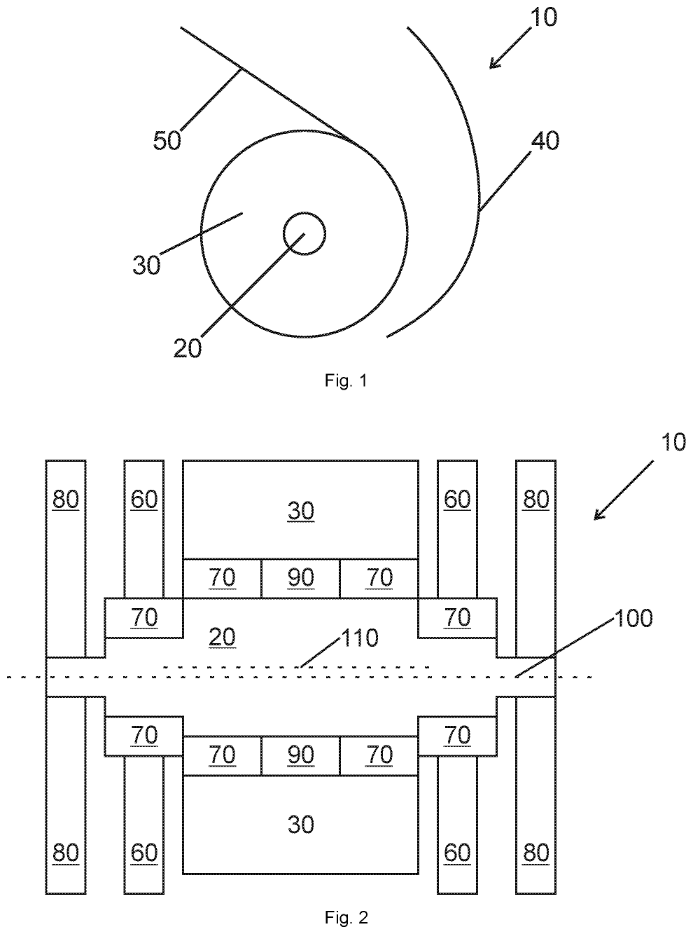

FIG. 1 Eccentric Roller Crusher

FIG. 2 First Example Cross Section

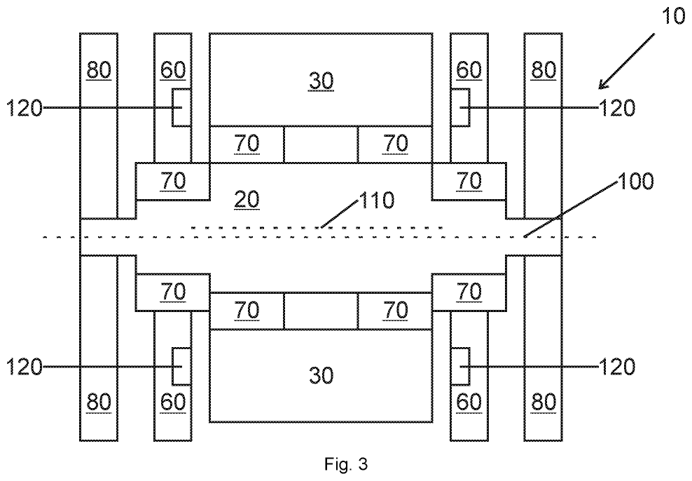

FIG. 3 Second Example Cross Section

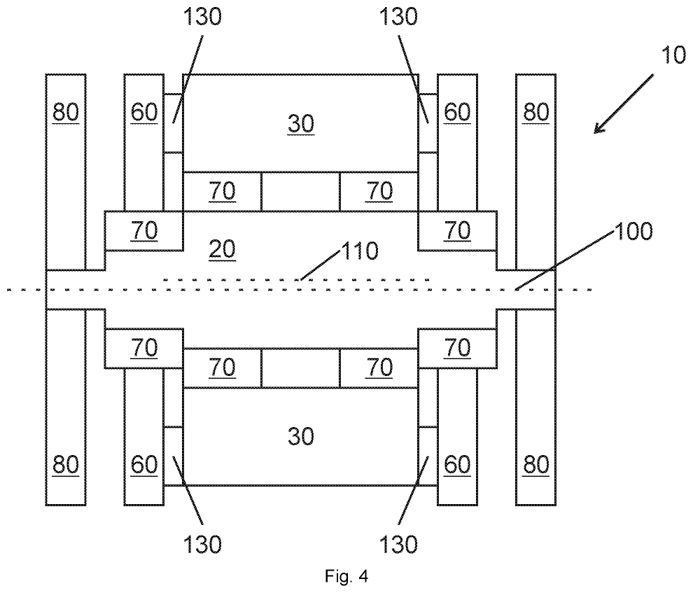

FIG. 4 Third Example Cross Section

In FIG. 1, a cross-section is shown vertical to the axis of rotation 100 through an eccentric roller crusher 10. At the top left, the material is introduced and slides over the material infeed 50, typically in the form of a grating in the region between roller 30 and rocker 40. Due to the eccentric support of the roller 30, the distance between the roller 30 and rocker 40, by which the material, which is greater, is crushed changes. Small material can already fall through the material infeed 50 designed as a grating and pass the roller 30 on the side opposite the rocker 40. As the roller 30 can freely rotate about the drive shaft 20, this is rotated anticlockwise in the case shown, while the drive shaft 20 is rotated clockwise.

In the following, three different illustrative embodiments of the retardation device are shown. To show this, the following depictions are not shown as a cross-section vertical to the axis of rotation 100, but as a vertical cross-section through the axis of rotation 100.

Using FIG. 2, initially, the structure of the three illustrative examples together and that known from the prior art are shown. The drive shaft 20 can rotate about the axis of rotation 100. To do this, the drive shaft is connected to the crusher housing 60 with two bearings 70. Additionally, the eccentric roller crusher 10 exhibits two flywheels 80, which are respectively arranged on the ends of the drive shaft 20. In the centre region, which is adjacent to the roller 30, the drive shaft 20 exhibits a thickening, which is not symmetrical to the axis of rotation 100, but exhibits a symmetrical axis 110 offset to the side of this. This achieves the eccentric support of the roller 30. The roller 30 is connected via two bearings 70 to the drive shaft 20 and is freely rotatable as a result.

In the first illustrative example shown in FIG. 2, the cavity 90 between the drive shaft 20, the roller 30 and the bearing 70 connecting both of these two parts is filled with a non-Newtonian shear-thickening fluid, for example, a starch solution. If the roller 30 is now accelerated abruptly, the shear velocity increases in a jump, by which the shear stress increases over-proportionally, that in turn brakes the roller 30. On the other hand, the shear velocity at usual rotational velocities is small, so that the shear stress is over-proportionally small, therefore represents hardly any resistance for the rotation of the shaft 30.

In the second illustrative example shown in FIG. 3, magnets 120 are embedded into the crusher housing 60 and generate eddy currents in the roller 30 and therefore brake it. Here too, at higher acceleration, the induced currents increase so that an increased braking force is exerted.

In the third illustrative example shown in FIG. 4, two fluid couplings 130 are arranged between the crusher housing 60 and the roller 30. For example, the pump wheel of the fluid coupling 130 is arranged on the roller 30 and the turbine wheel of the fluid coupling 130 is arranged on the crusher housing 60. For example, the fluid coupling is filled with silicone oil, as this exhibits high long-term stability.

### REFERENCE NUMBERS

10 Eccentric Roller Crusher
20 Drive shaft
30 Roller
40 Rocker
50 Material Infeed
60 Crusher Housing
70 Bearing
80 Flywheel
90 Cavity
100 Axis of Rotation
110 Axis of Symmetry
120 Magnet
130 Fluid Coupling

1. Eccentric roller crusher (10) with a crusher housing (60), a drive shaft (20), a roller (30) supported eccentrically and rotatably on the drive shaft (20) and a rocker (40), characterised in that between the drive shaft (20) and the roller (30) or between the roller (30) and the crusher housing (60) a retardation device is arranged.

2. Eccentric roller crusher (10) in accordance with claim 1, characterised in that the retardation device exhibits a fluid.

3. Eccentric roller crusher (10) in accordance with claim 2, characterised in that the retardation device exhibits a non-Newtonian shear-thickening fluid.

4. Eccentric roller crusher (10) in accordance with any one of claims 2 to 3, characterised in that the retardation device exhibits a fluid coupling (130).

5. Eccentric roller crusher (10) in accordance with claim 1, characterised in that the retardation device exhibits a counter-rocker, wherein the counter-rocker is arranged on the side of the roller opposite the rocker, wherein the material infeed is formed in the shape of a screen or grating.

6. Eccentric roller crusher (10) in accordance with claim 5, characterised in that the gap between the counter-rocker and the roller is smaller than the opening size of the grating or screen.

7. Eccentric roller crusher (10) in accordance with claim 1, characterised in that the retardation device exhibits a magnetic brake.

8. Eccentric roller crusher (10) in accordance with claim 7, characterised in that the magnetic brake exhibits an electromagnet and is therefore switchable.
